(19) United States
(12) Patent Application Publication
(10) Pub. No.: US 2011/0185877 A1
(43) Pub. Date: Aug. 4, 2011

(54) STRINGED MUSICAL INSTRUMENT

(76) Inventors: Sunny Ahn, Los Angeles, CA (US); Hyo E. Ahn, Los Angeles, CA (US)

(21) Appl. No.: 13/084,313

(22) Filed: Apr. 11, 2011

Related U.S. Application Data
(63) Continuation-in-part of application No. 12/505,205, filed on Jul. 17, 2009, now Pat. No. 7,939,735.

(51) Int. Cl. G10D 3/00

(52) U.S. Cl. 84/291

(57) ABSTRACT

The present subject matter relates to novel soundboard apparatus for stringed musical instruments. Specifically, the present subject matter teaches an apparatus capable of enhanced phonetic quality, improving the phonetic consistency of a stringed musical instrument, and enhancing resonance in a stringed musical instrument, while further providing a means for assembly and disassembly for the purpose of transport, repair, and replacement.

### CROSS-REFERENCE TO RELATED APPLICATIONS

This application is a continuation-in-part of U.S. application Ser. No. 12/505,205, filed Jul. 17, 2009, now allowed, the contents of which are hereby incorporated by reference in their entirety.

### FIELD OF THE INVENTION

The present field of the subject matter relates to stringed musical instruments. More specifically, the present subject matter relates to a harp, which is a stringed instrument with the plane of its strings positioned substantially perpendicular to the ground and/or a soundboard.

### BACKGROUND OF THE INVENTION

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

The harp is a stringed musical instrument consisting of a rigid, triangular frame within which are stretched a set of substantially parallel strings. The strings run between the top, or neck, of the harp, to the resonator/soundboard. The neck and soundboard are joined together, with the strings set at a substantially perpendicular angle relative to the soundboard. (By contrast, in other harp-like instruments such as the lyre and zither, the strings run parallel to the soundboard). Ancient and primitive harps lacked the third rigid member of contemporary frame harps, termed the pillar or column, which extends from the neck down to the lower end of the soundboard. The strong structure provided by the column allows for increased string tension that produces notes of a higher pitch than was possible with early harps. The instrument is generally placed on the floor in front of the harpist and played by tilting it back so that the instrument rests against the harpist's shoulder and plucking the strings from either or both sides with the fingers of the hand(s). Alternatively, the instrument may be placed on the lap of the harpist and played in a like fashion.

The modern concert harp stands approximately 170 cm high (5.5 ft) and has the largest phonetic range of any instrument in an orchestra: more than 6½ octaves (from the lowest C on the piano to the highest G). Its structure consists of a tapering, hollow body (the “soundbox”), wherein the tapering results from a large width at the bottom base and a narrower width at the top. The soundbox is coupled with a thin wooden plank (the “soundboard”), which is attached at the top to a doubly curved neck that is embedded with a set of tuning pins. The pillar, or column, is attached to the neck and towards the bottom base of the soundboard, creating an open triangular shape between the soundboard, neck, and column. The strings are positioned in a vertical orientation in a plane substantially perpendicular to the soundboard. At the base of the modern concert harp are seven pedals, one for each degree of the diatonic scale. These pedals, mechanically connected through the pillar to two rows of rotating pronged discs placed under all of the strings for each degree of the scale either a semitone (pedal at half hitch activating discs in the first row) or a whole tone (pedal fully depressed activating discs in the second row). Thus the instrument is totally chromatic (a sequence of notes proceeding by semitones). The harp is strung in gut or nylon in the upper and middle registers. The bass strings are generally of over-spun wire. Aside from the modern concert harp (also known as the pedal harp), a second popular type of harp is the folk harp (also known as the Celtic harp). Whereas a concert harp rests on the ground, the folk harp is held in the hands of the player or rested in the lap and as such, is smaller and portable.

The chromatic flexibility offered by the concert harp, along with a growing desire for orchestral color, makes the harp increasingly appealing to musicians and composers. Historically, the instrument has enjoyed being a regular member of the orchestra of Berlioz, Wagner, and Tchaikovsky. However, the overgrown size, weight and cost associated with modern day concert harp renders the instrument inaccessible to a majority of would-be harpists, composers and musicians. (see U.S. Pat. No. 7,794,495).

In operation, the harp is played by plucking the strings with the pad of the fingers to make a warm, mellow tone, or to use the tip of the fingers creating a sharper sound. Harp players use all of the fingers except for the little finger, which is generally too short and weak to effectively pluck a string. Most types of harps only require use of the hands, with the exception of the concert harp, in which the feet are also used to operate foot pedals. The plucking of strings creates resonance which excites air molecules, creating sound. The soundboard enhances the volume and tone of the sound created by plucking the strings. The soundboard, attached to a hollow chambered soundbox, enables the instrument to amplify and produce a clean, focused, natural sound by transferring the sound to the surrounding air.

Sound produced through string vibration resonates through the attached soundboard and is further amplified through the coupled soundbox. In a traditional design, the soundbox contains sound holes found on the “backside” of the harp instrument (i.e., side opposite the strings). The sound holes are placed on the backside of the harp instrument largely by necessity, since the soundboard captures vibration emanating from pulling of the attached strings by resonance. The presence of sound holes on the same surface or near the location of string attachment would cause a loss of surface material for effective sound resonance and reduce mechanical strength to resist tension force from pulling of the attached strings. As a result of this traditional design, sound is not channeled from the soundbox in the direction towards the audience or listener, because the sound holes do not face them. Instead, the sound holes face the harpist, whose positioning causes blockage or diffraction of air molecules, diminishing the intensity of sound emanating from the instrument. Blockage and diffraction may compromise the intensity and purity of sound presented, creating an auditory experience of lower satisfaction to the listener.

Furthermore, present stringed instrument designs suffer from other design flaws. Existing stringed instruments attach the column at the bottom of the soundboard closest to the bass strings. (see U.S. patent application Ser. No. 09/567,145). In the case of a harp, the column is attached to the soundboard by a large wood screw or bolt that passes through the column and soundboard. Variations in design have eliminated this wood screw or the use of a bolt at this point, but as a general matter, the resistance to the tension of the strings on the board remains concentrated in one small area at the bottom of the soundboard. This area is referred to as the “yoke” and is one of the most troublesome parts of a harp. Other than creating a point of design weakness, the attachment of the column near the bass strings compromises the quality of sound and reduces resonance, leading many instrument players to resist using the very lowest strings. Accordingly, the amount of resonance created by the soundboard near the column is restricted and so stiff that it can only produce about a quarter of the response found at other positions along the soundboard.

Further, when strings are fully tensioned, they impose mechanical tension and shear loads on the soundboard, causing deformation. Prolonged use over time, such as a period of several years, leads to an elastic deformation in the board known as a “belly”. The presence of a belly on a soundboard is associated with the “opening up” of a harp's range of tonal qualities, due to enlargement of the hollow chamber within the soundboard and soundbox, positioning of strings (relative to the player and soundboard) and subtle changes in string tension, which collectively result from the changes in the soundboard surface. The belly imparts some desirable and unique sound characteristics associated with an individual instrument. However, permanent deformation of the soundboard, known as “creep”, is demonstrated by the presence of the belly, even after removal of the strings, thereby indicating permanent steady state changes in the materials forming the soundboard. At a later stage, if expansion of the belly continues or accelerates, this may demonstrate tertiary creep, wherein rupture of the belly eventually occurs from extended use, due to failure of the materials forming the soundboard. As a result, removing and repairing/replacing the soundboard, an expensive and time-consuming process, is necessary to restore function of the harp. A soundboard assembly with removable parts would eliminate mechanical stresses associated with tension from pulling the strings of a stringed instrument, while further providing a convenient, easy, and accessible means for replacement and repair as necessary. (see U.S. Pat. No. 6,262,353).

In the case of a harp, strings are attached at the neck by the means of tuning pins. Generally, there are three types of tuning pins used for harps, including tapered, threaded, and zither pins, all of which are embedded within the neck of the harp. Both tapered and threaded harp pins go all the way through the neck of the harp. Drilling a hole completely through the neck of the harp removes the wood material which the neck is comprised of. Furthermore, the pins act as wedges to split the grain of the wood, thereby removing strength and rigidity from the neck. Traditionally, tapered pins were used in harps, wherein the pin itself has a larger cross-sectional diameter on the non-stringed side of the instrument, than the cross-sectional diameter on the stringed side of the instrument. The tapered pin is held in place in the neck through a similarly tapered hole drilled into the neck of the instrument, wherein the tapered tuning pin is held by friction and tension of the metal against the surface of the wooden hole. As a result of the high tension needed to hold the pin in place, fine or graduated adjustment of a tapered tuning pin, for the purpose of changing the tension on the attached string is difficult, since movement of the pin is primarily performed by pulling or pushing the tapered pin in or out of the tapered hole, or rotating the pin within the hole. Either method changes the angle of the string relative to the neck, thereby adjusting the tension, sound and tone emanating from the attached string. In contrast, threaded pins are patterned with a very fine screw thread in the mid-section of the pin, which interlock with a similar threaded groove pattern inside matching holes drilled into the neck. The grooved threads in the screw and within the hole create friction to hold the pin in place. By rotating the pin, fine or graduated adjustment is achieved by incremental movements of the pin in and out of the hole, achieved by rotation of the threaded pins. These rotations gradually change the angle of the string relative to the neck, and adjust the tension, sound and tone emanating from the attached string. The third kind of harp pin, the zither tuning pin, is similar to the threaded tuning pin, as it contains a threaded grooved element, which interlocks when placed in a hole containing a threaded groove pattern drilled into the neck. However, unlike either a tapered or threaded tuning pin, a zither tuning pin does not go through the wood plane of the instrument. The tip of the zither tuning pin remains inside the wood of the neck, thereby reducing the amount of material removed from the neck, increasing strength and providing structural rigidity. Conventional tuning pins, of either the tapered, threaded, or zither type variety typically require use of a tuning wrench, wherein the wrench contains a hollowed “female” element for attachment to a “male” tip element located on the tuning pin, and the female element contains features interlocking with corresponding features on the male tip. Common examples include square-shape tip or an 8-pointed star-shaped tip. Use of a tuning wrench is necessary to securely grip, turn and adjust the tuning pin. However, this requires additional equipment from the owner, which in the case of misplacement or loss of a tuning wrench, causes inconvenience or limits opportunity for on-the-spot adjustments by the instrument user. Similar stringed instruments would further benefit from improved tuning pin design allowing the user graduated adjustment of strings without the use of specialized tools. (see U.S. Pat. No. 5,442,987).

Thus, there exists a need in the art for a stringed instrument capable of delivering clean, sharp notes with reduced incidents of diffraction. In addition, there is a need in the art for an economical, quality stringed instrument capable of quick and convenient assembly and disassembly for transport, modification or repair. Finally, there is a need in the art for an apparatus and method for tuning an instrument without the use of specialized tools.

### SUMMARY OF THE INVENTION

The following embodiments and aspects thereof are described and illustrated in conjunction with compositions and methods which are meant to be exemplary and illustrative, not limiting in scope. The present invention provides an assembly for a stringed instrument, comprising a front plate, a rear plate, two side walls, and a top plate, the two side walls each attached on one end to the front plate, each attached at another end to the rear plate, and the top plate attached to the front plate, rear plate and two side walls thereby forming a hollow core, means for removable attachment configured on the top plate and at least one sound hole in the front plate. In another embodiment, the means for removable attachment is selected from the group consisting of pegs, dowels, screws, hollowed couplings, magnetic plates, snap fittings, nuts, bolts and combinations thereof. In another embodiment, the at least one sound hole is independently selected from the group consisting of circles, semi-circles, oblong variants of circles and semicircles, wedges, slices, irregular shapes and combinations thereof. In another embodiment, the rear plate further comprises at least one sound hole. In another embodiment, the assembly further comprises at least one additional side wall. In another embodiment, the assembly further comprises a bottom plate attached to the front plate, rear plate and two side walls. In another embodiment, the rear plate and two side walls comprise curvilinear edges so as to form a substantially rounded shape.

In an additional embodiment of the present invention a combination of the assembly of and a stringed instrument comprises a soundboard, wherein the stringed instrument comprises means for instrument removable attachment on the soundboard, adapted to removably interact with the means for removable attachment configured on the top plate. In another embodiment, the means for instrument removable attachment is selected from the group consisting of pegs, dowels, screws, hollowed couplings, magnetic plates, snap fittings, nuts, bolts and combinations thereof. In another embodiment, the stringed instrument further comprises a neck connected to the soundboard, a column mounted on the soundboard and a plurality of strings connected between the soundboard and the neck. In another embodiment, the stringed instrument further comprises a plurality of pins mounted on the neck, wherein the plurality of strings are attached to the pins. In another embodiment, the soundboard comprises at least two notches for attachment of a plurality of strings. In another embodiment, the combination further comprises a strip fixed on the soundboard for attaching a plurality of strings.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a stringed musical instrument in accordance with an embodiment of the present subject matter, including a rear-facing sound hole

FIG. 2 depicts a stringed musical instrument in accordance with an embodiment of the present subject matter. Panel A depicts a front-facing view of a stringed instrument attached to a soundboard with a front-facing sound hole. Panel B depicts a smaller stringed instrument for portable use.

FIG. 3 depicts a soundboard for a stringed musical instrument, including an expanded view of the bracing and notches, in accordance with an embodiment of the present subject matter.

FIG. 4 depicts a stringed musical instrument, including an expanded view of the bottom of the instrument containing a means for attachment, in accordance with an embodiment of the present subject matter. Panel A depicts a smaller stringed instrument attached to a soundbox. Panel B depicts a larger stringed instrument attached to a soundbox of increased height and volume. Combinations of stringed instrument and soundbox size, in terms of height, width and volume can be varied depending on the needs of the instrument user. Panel C depicts a stringed instrument detached from a soundbox. Panel D is an expanded view of the bottom of the instrument depicted in panel C showing holes, dowels and magnetic plates which can attach the instrument to a soundbox. Panel E is a direct view of the same bottom of the instrument depicted in panel C.

FIG. 5 depicts the bottom of a stringed musical instrument and soundboard for a stringed musical instrument, each containing a means for attachment, in accordance with an embodiment of the present subject matter. Panel A depicts the bottom of a stringed instrument showing holes, dowels and magnetic plates which can attach the instrument to a soundbox, panel B is a direct view of the same. Panel C depicts the bottom of a stringed instrument with a rounded wall. Panel D depicts a soundbox showing pegs, holes, and magnetic plates which can attach to the bottom of the instrument depicted in panel A. Other versions containing rounded walls are depicted in panels E and F.

FIG. 6 depicts sound holes on a soundboard, in accordance with various embodiments of the present subject matter.

FIG. 7 depicts the neck of a stringed instrument and tuning pins, in accordance with various embodiments of the present subject matter.

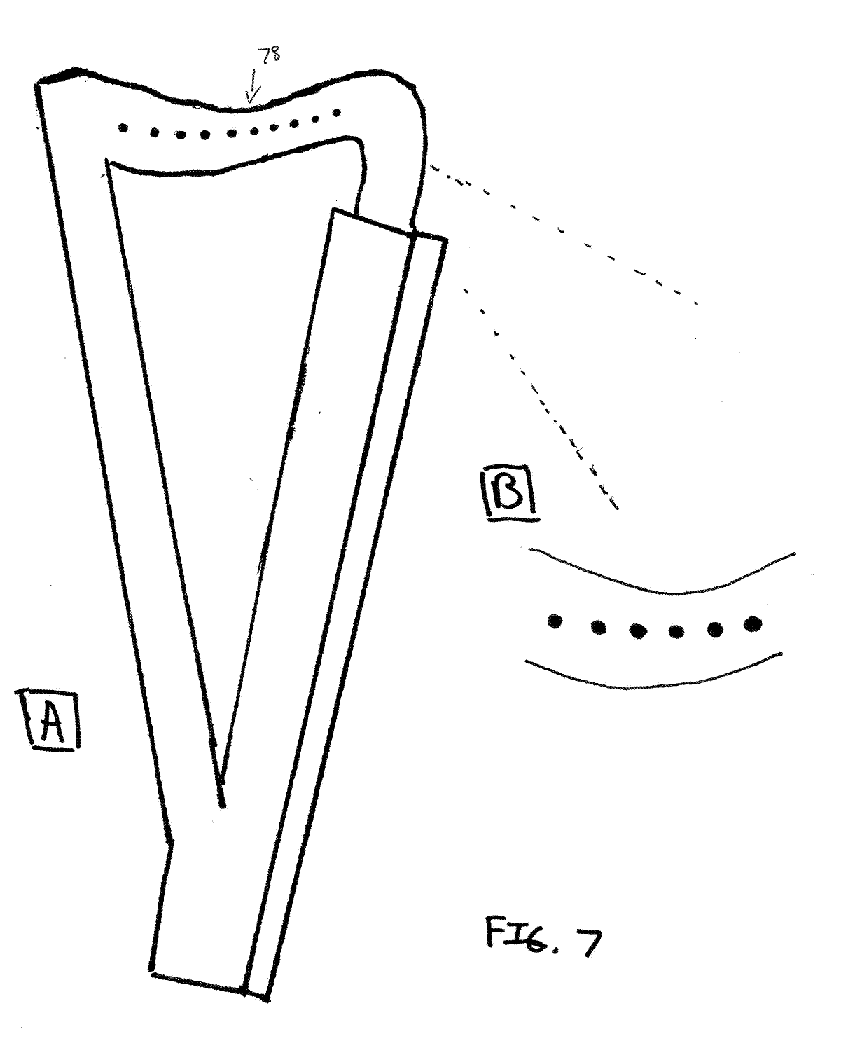

### DETAILED DESCRIPTION OF THE INVENTION

All references cited herein are incorporated by reference in their entirety as though fully set forth. Unless defined otherwise, technical terms used herein have the same meaning as commonly understood by one of ordinary skill in the art to which the subject matter belongs. One skilled in the art will recognize many methods and materials similar or equivalent to those described herein, which could be used in the practice of the present subject matter. Indeed, the present subject matter is in no way limited to the methods and materials described.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

“Soundboard assembly” as used in this application, is an element including a soundboard and a soundbox, wherein a soundboard is a flat surface and a soundbox is one or more pieces of material forming a hollow core.

The present subject matter comprises a new soundboard assembly and design for stringed musical instruments, as well as a new stringed musical instrument and design, both configured to enhance phonetic quality, improve the phonetic consistency of a stringed musical instrument, and enhance the resonance in a stringed musical instrument, all while reducing construction and repair cost and eliminating the cumbersome size associated with comparable stringed musical instruments. The present subject matter further discloses a means for producing a wide spectrum of chromatic sound using the contemplated soundboard assembly and stringed musical instrument. Application of the present subject matter may be utilized on various stringed instruments including, lyres, aeolian harps, autoharps, kitharas and other zither family instruments.

Aspects of the present invention include a soundboard assembly that improves upon the phonetic quality of existing stringed instruments by allowing the vertical column to be mounted at or about the center of a soundboard. The contemplated orientation for mounting the vertical column at the center of the soundboard eliminates or substantially reduces phonetic inconsistencies observed at the “yoke” of common stringed instruments, thus allowing for greater variance in the spectrum of chromatic sound. This is accomplished by providing greater vibrational freedom in a soundboard, as the column is no longer attached to the base of the soundboard. In addition, the contemplated orientation of mounting the vertical column at about the center of the soundboard provides a greater amount of surface area material allowing placement of sound holes in the soundboard and towards the audience/listener.

In other embodiments of the present invention, the soundboard assembly comprises a soundboard removably attachable to a soundbox. In this aspect of the present invention, the soundboard is a discrete structural element separate from the panels forming the soundbox, thereby allowing design of the soundbox for improved acoustic characteristics with fewer restrictions imposed by the need for surface material for proper resonance and mechanical strength due to the attachment of strings, as is the case in a traditional design. Further, removable attachment between the soundbox and soundboard of a stringed instrument, allows convenient assembly and disassembly of the instrument for transport and repair, without sacrificing the acoustic benefits of a larger instrument of fixed height and width.

The placement of sound holes at various positions in the soundboard and/or soundbox allows sound resonating in the soundboard to be disseminated from the front of the musical instrument directly to the listening audience. The unobstructed dissemination of sound from the musical instrument through the sound hole to the audience leads to enhanced phonetic quality and a cleaner presentation of sound by the instrument. Furthermore, the contemplated orientation of mounting the vertical column at about the center of the soundboard reduces the cumbersome size of modern concert harps, as well as reducing the cost of production and maintenance, all the while enhancing the phonetic and chromatic qualities of the stringed musical instrument. Throughout the description, the present subject matter is shown in a substantially vertical orientation, although it may suitably be shown in any orientation. Therefore, the terminology “upper”, “lower”, “top”, “bottom”, “front”, “side”, “rear” and other terms should be construed as descriptive and not limiting.

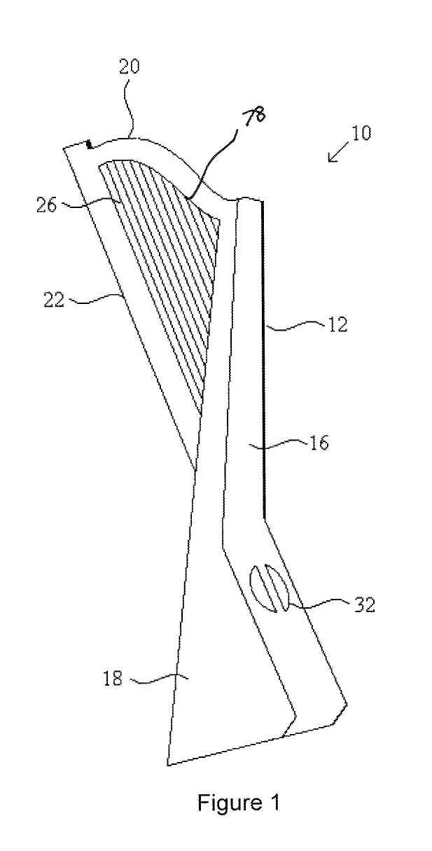

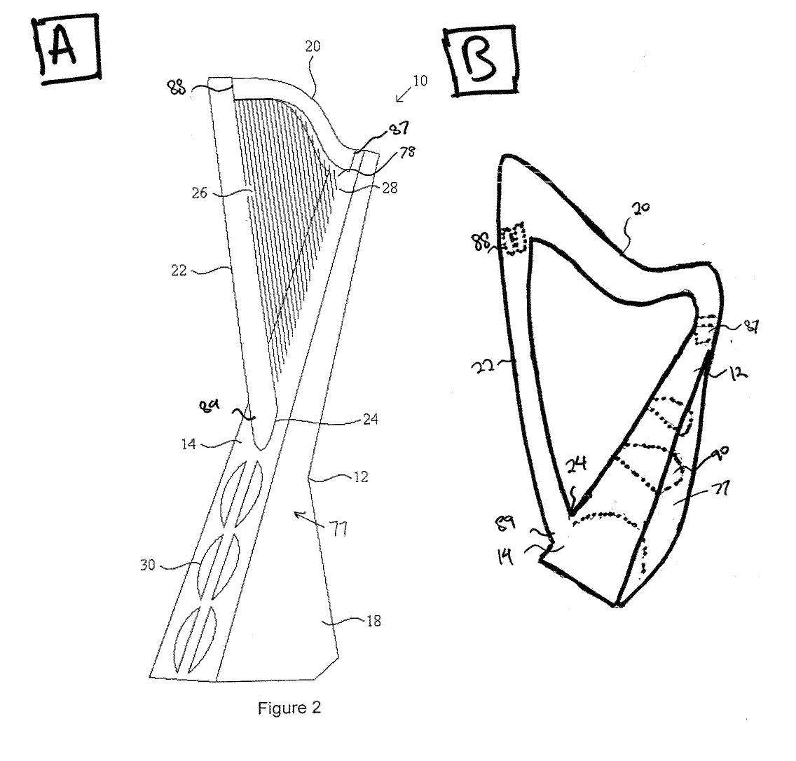

As seen in FIGS. 1 and 2, the present subject matter teaches a stringed musical instrument 10 with a soundboard assembly 12, a curved neck 20, column 22 and a plurality of individual strings 26. A substantially rectangular soundboard 14 is attached to side walls 18 in a perpendicular fashion along the longer edges of the substantially rectangular soundboard 14. The side walls 18, extending outwards from the rectangular soundboard in the same direction, are attached to a rear plate 16 in a perpendicular fashion. The soundboard 14, side walls 18, and a rear plate 16 form a hollow core soundbox 77. The soundboard assembly 12, formed by soundboard 14 and soundbox 77, rests substantially vertical to the ground, with the longest dimension of the soundboard assembly extending upwards from the ground. At the top or upper portion of the soundboard assembly 12, a curved neck 20 is connected at one end and is positioned substantially parallel to the ground. At the other end of the curved neck 20, opposite the attachment site of the soundboard assembly 12, a column 22 is connected to the curved neck 20. The column 22 extends down to about the center of the soundboard 14. In combination, the soundboard assembly 12, neck 20 and column 22 establish an open triangular shape. By virtue of connecting the column 22 to about the midpoint of the soundboard 14, the open triangular shape is necessarily positioned in the upper half of the stringed instrument 10, up and away from the ground.

As further depicted in FIGS. 1 and 2A, a plurality of individual strings 26 are stretched in the open triangular shape between the neck 20 and the soundboard 14, in a plane substantially perpendicular to the soundboard 14. Individual strings 26 are attached at one end, to the neck 20 by tuning pins 78 embedded within the neck 20. At the other end, the individual strings are secured to a strip 28 that is fixed centrally and axially on one or both sides of the soundboard 14 and positioned in the upper portion of the soundboard 14 (i.e., section above the center of the soundboard). The pull of the strings 26 is resisted on the bass end by the column 22 and on the treble end by the neck 20. The curvature of the neck 20 is the result of an effort to employ lengths that are correlated to the thicknesses of the strings 26 so as to yield a pleasant tone when the strings 26 are plucked. A lower portion of the soundboard 14 (i.e., section below the center of the soundboard) has at least one sound hole 30 for disseminating sound resonating from the soundboard 14 for direct dissemination of sounds to the listening audience. FIG. 2B depicts a smaller stringed instrument for portable use containing a hollow core soundbox 77, curved neck 20 and column 22. In various embodiments of the stringed instruments depicted in FIGS. 2A and 2B, one end of the curved neck 20 is attached to the top end of the soundbox 77 in a flat plane 87 substantially parallel to the ground. In other embodiments of the stringed instruments depicted in FIGS. 2A and 2B, one end of the curved neck 20 is attached to the top end of the column 22, in a flat plane 88 substantially parallel to the ground. In another embodiment of the stringed instruments depicted in FIGS. 2A and 2B, the bottom end of the column 22 is attached at a point on the soundboard 14 in a flat plane 89 substantially parallel to the ground.

In various embodiments, the soundboard 14, one or more side walls 18, and rear plate 16, each constitute various shapes, including rectangles, squares, rhombii, triangles, trapezoids, polygons, circles, ovals, curvilinear, irregular shapes and substantially similar geometric forms in two dimensions. In other embodiments, various combinations of a soundboard 14, one or more side walls 18, and a rear plate 16 form a soundboard assembly 12, constituting rectangles, squares, rhombii, triangles, trapezoids, polygons, circles, ovals, curvilinear, irregular shapes and substantially similar geometric forms in three dimensions with a hollow core. Other shapes readily known to one of skill in the art may be used in combination for plates and widewalls in two or three dimensions.

In another embodiment, depicted in FIG. 1, the soundboard assembly 12 has at least one sound hole 32 situated in the rear plate 16. Furthermore, the soundboard 14 may contain bracing 64 that is fixed centrally and axially on one or more outside edges of the soundboard 14, for bracing the strings to the soundboard, thus reducing deflection in the soundboard surface.

The present subject matter further teaches the elimination of the deleterious effect of the column on the bass tones of a stringed musical instrument. As stated prior, common stringed instruments place the end of the column at the bottom of the soundboard closest to the bass strings. This area is referred to as the “yoke” and due to the positioning of the column near the bass strings, sound produced by these strings are inaccurate and lead to a compromise in sound quality and instrument structure.

By attaching the column away from the bottom of the soundboard this weakness in the design of the yoke is eliminated, and the soundboard is allowed greater resonance and flexibility, resulting in greater and more consistent vibrational freedom in the soundboard. The improvements in vibrational freedom result in a broader and more accurate range of tones in the instrument, the favorable use of all strings providing a mellower sound.

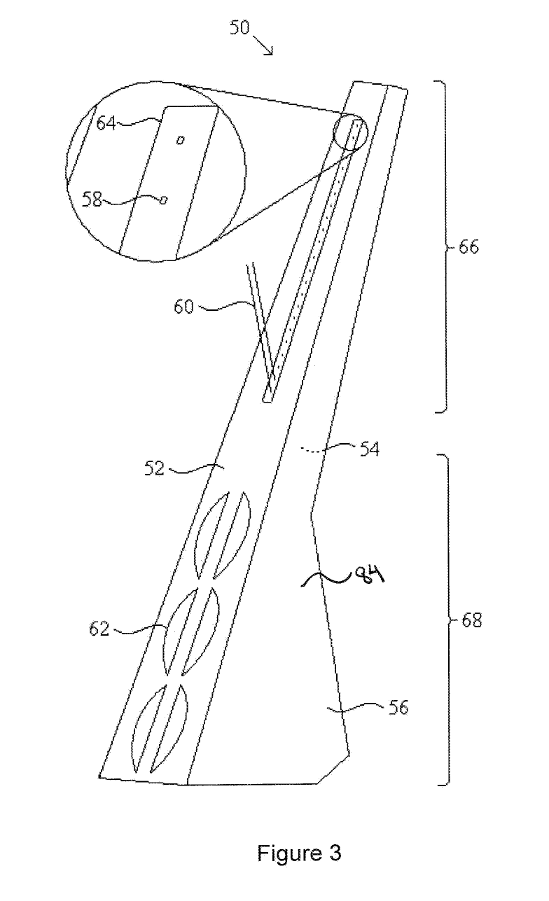

FIG. 3 depicts an improved soundboard assembly 50, in accordance with the present subject matter, for use in different types of stringed instruments. In this regard, the subject matter soundboard assembly 50 may be applied to other instruments such as lyres, aeolian harps, autoharps, kitharas and other zither family instruments. The contemplated soundboard assembly 50 has a soundboard 52, rear plate 54 and side walls 56 to form a hollow core soundbox 84. In some embodiments, the soundboard assembly 50, formed by soundboard 52 and soundbox 84, is a soundboard 52 with at least two notches 58 for attaching a string 60 to each notch 58 on the soundboard 50. In some embodiments, the notches 58 are positioned at about the center of the sound board 52 of the soundboard assembly 50 and continues longitudinally towards the upper portion 66 of the soundboard 52 of the soundboard assembly 50, wherein the upper portion 66 is opposite a lower portion 68 closest to the ground. In some embodiments, the soundboard 52 of the soundboard assembly 50 also contains at least one sound hole 62 for disseminating sound created by the strings 60 and resonating from the soundboard 52. In other embodiments, a plurality of individual strings may be positioned in a plane substantially parallel to the soundboard along the length of each individual string, with each individual string attached to two or more notches positioned at any point along the soundboard surface. In other embodiments, the plurality of individual strings positioned are in a plane substantially perpendicular to the soundboard along the length of each individual string, with each individual string attached to one or more notches positioned along the soundboard surface, and further attached to a neck, column, or other structural feature extending outward from the soundboard. In other embodiments, the soundboard assembly is positioned in substantially vertical orientation relative to the ground, wherein the longest dimension of the soundboard assembly extends upward from the ground. In other embodiments, the soundboard assembly is positioned in substantially horizontal position relative to the ground, wherein the shortest dimension of the soundboard assembly extends upward from the ground.

In various embodiments, the soundboard 52, one or more side walls 56, and rear plate 54, each constitute various shapes, including rectangles, squares, rhombii, triangles, trapezoids, polygons, circles, ovals, curvilinear, irregular shapes and substantially similar geometric forms in two dimensions. In other embodiments, various combinations of a soundboard 50, one or more side walls 56, and a rear plate 54 form a soundboard assembly 52, constituting rectangles, squares, rhombii, triangles, trapezoids, polygons, circles, ovals, curvilinear, irregular shapes and substantially similar geometric forms in three dimensions with a hollow core. Other shapes readily known to one of skill in the art may be used in combination for plates and widewalls in two or three dimensions.

As seen in FIG. 3, bracing 64, to resist deformation caused by the pull of the strings 60 on the soundboard 50, is typically placed inside and/or upon the edges of the soundboard assembly 52 adjacent to the notches 58 found at regular intervals. This bracing 64 can be of wood, metal, composite, or combinations thereof. The pull of the strings 60 imparts an upward curve to the soundboard 50 which translates into a force that brings the edges of the soundboard 50 closer together. Bracing 64 is needed to resist this pull.

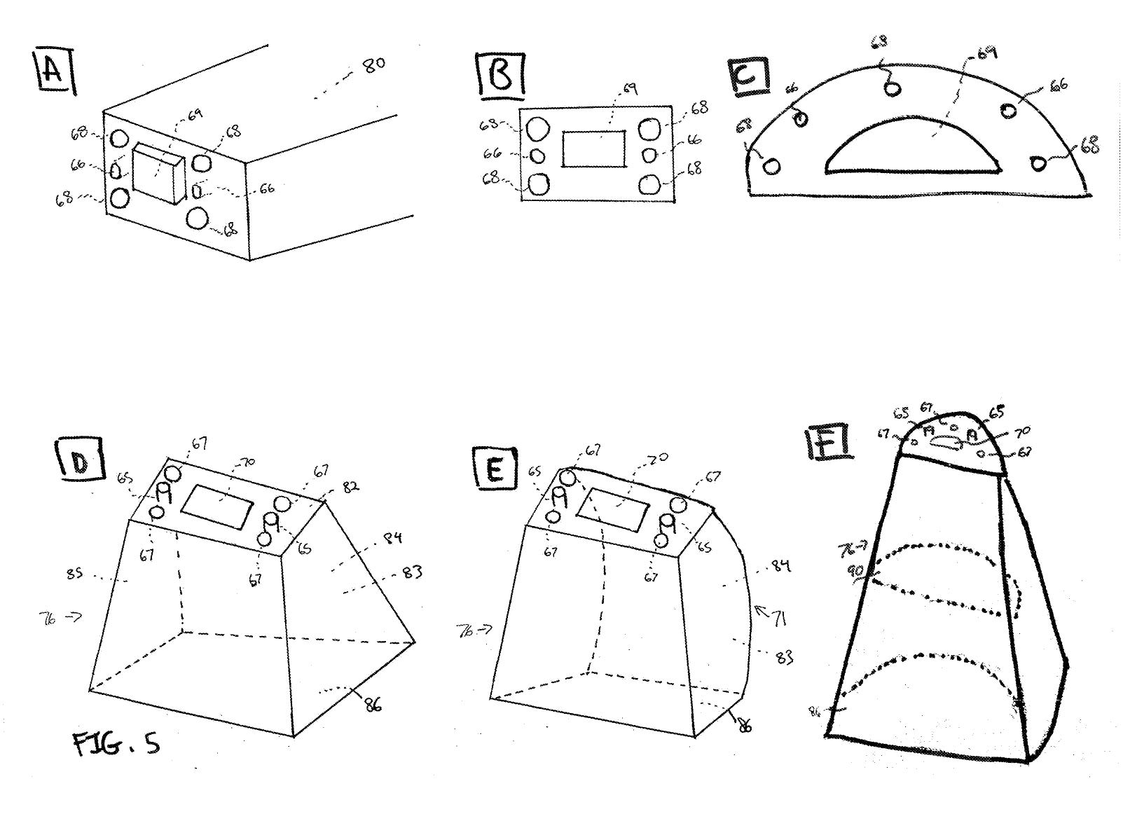

In another embodiment, the present invention is a soundbox 76 formed as a separate and removably attachable piece from the soundboard 80 of a stringed instrument 81. In one embodiment, a hollow core soundbox 76, as depicted in various embodiments in FIGS. 5D-F, has a top plate 82 containing one or more outward extending pegs 65. The pegs 65 of the soundbox 76 are inserted into corresponding recessed hollow couplings 66 and 70, provided on the bottom plate 82 of a substantially rectangular flat surface area soundboard 80 for a stringed instrument 81 as depicted in FIG. 5A-C. This design allows quick attachment and detachment of a soundbox 76 from the soundboard 80 of a stringed instrument. By designing the soundbox 76 as a separate and removably attachable piece from the soundboard 80 of a stringed instrument 81, the soundbox may be designed for improved acoustic characteristics with fewer restrictions imposed by the need for surface material for proper resonance and mechanical strength due to the attachment of strings, as is the case in a traditional design. In one embodiment, the stringed instrument is a harp, wherein the soundboard of the harp is removably attachable to a soundbox. In another embodiment, the soundbox rests on the ground with the top plate facing upwards and is attached via the bottom plate to the soundboard of the harp.

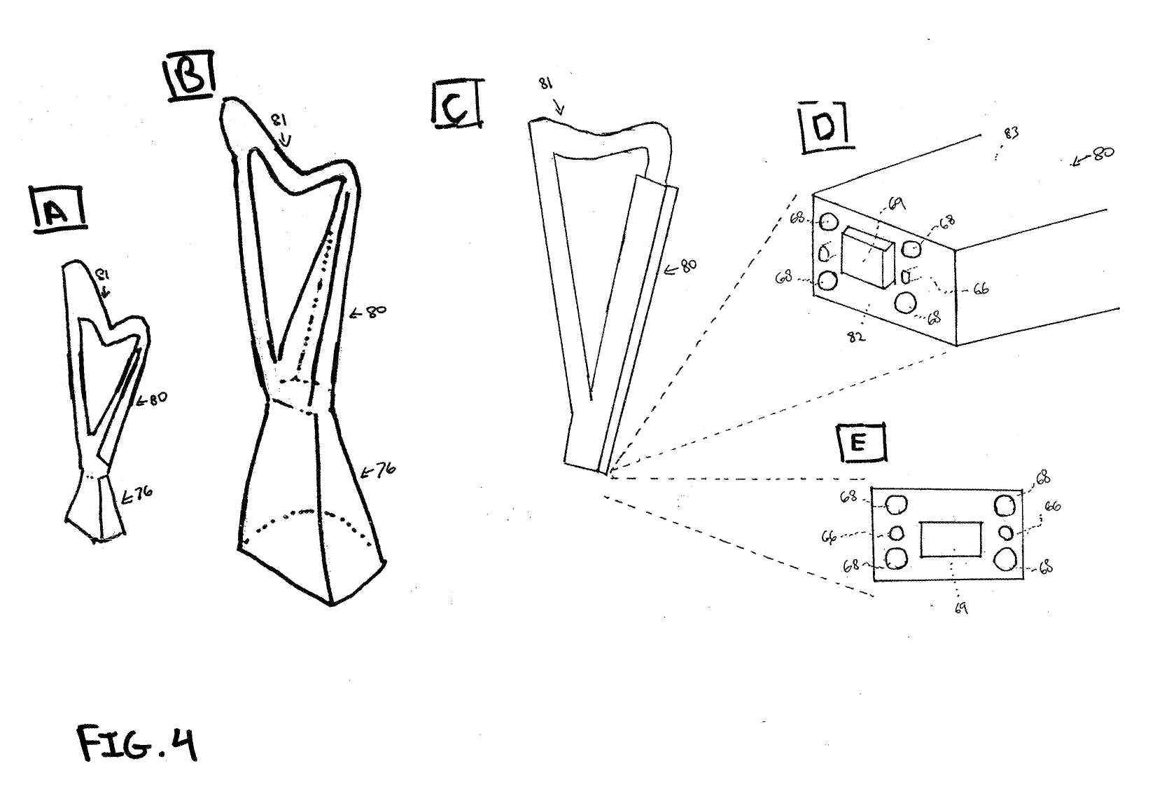

In various embodiments, the soundbox 76 contains a top plate 82, two side walls 83, a front 85 and rear plate 84 to form a hollow core as depicted in FIGS. 5D-F, wherein the two side walls 83 are attached along the edges of the front plate 85 in a perpendicular fashion, further attached to the rear plate 84 in a perpendicular fashion, with the top plate 82 attached to the two side walls 83 and rear plate 84 in a perpendicular fashion. In certain embodiments, the soundbox 76 has an additional bottom plate 86 to fully enclose the hollow core. In another embodiment, the soundbox 76 contains an additional flat surface of material 90 within the hollow core substantially parallel to the top plate 82 in order to create a plurality of hollow cores within the soundbox 76. In various embodiments, the soundboard 80 is a substantially rectangular flat surface area as depicted in FIG. 4C. In another embodiment, the soundboard 80 is a substantially rectangular flat surface area of solid composition. In another embodiment, the soundboard 80 contains a bottom plate 82 and one or more side walls 82, wherein the one or more side walls 82 are attached along the edges of the bottom plate 82 in a perpendicular fashion to form a hollow core.

In various embodiments, the soundbox 76, top plate 82, two side walls 83, front 85 and rear plate 84, each constitute various shapes, including rectangles, squares, rhombii, triangles, trapezoids, polygons, circles, ovals, curvilinear, irregular shapes and substantially similar geometric forms in two dimensions. In various embodiments, the soundbox 76, top plate 82, two side walls 83, front 85 and rear plate 84, each constitute various shapes, including rectangles, squares, rhombii, triangles, trapezoids, polygons, circles, ovals, curvilinear, irregular shapes and substantially similar geometric forms in three dimensions with a hollow core. In various embodiments, the soundboard 80 and one or more side walls 82, each constitute various shapes, including rectangles, squares, rhombii, triangles, trapezoids, polygons, circles, ovals, curvilinear, irregular shapes and substantially similar geometric forms in two dimensions. In other embodiments, various combinations of a soundboard 80 and one or more side walls 82, constitute rectangles, squares, rhombii, triangles, trapezoids, polygons, circles, ovals, curvilinear, irregular shapes and substantially similar geometric forms in three dimensions with a hollow core. Other shapes readily known to one of skill in the art may be used in combination for plates and widewalls in two or three dimensions.

In alternative embodiments, pegs may be of variable shape and size, examples include circle columns 66, square columns 69, squared circle columns, circle-star (e.g. notched) columns, and pyramidal shapes, among others. In another embodiment, magnetic plates 67 are adjacent to the pegs on the top part of the soundbox 76, wherein other magnetic plates 68 are present on the bottom part of the stringed instrument and provides an additional force for attachment strength between the soundbox 76 and soundboard 80 of a stringed instrument 81 as a result of electromagnetic attraction as depicted in FIGS. 5A-F and FIGS. 4A and B. While the position of the various magnetic plates, 67 and 68, on the soundbox 76 and the soundboard 76 of a stringed instrument 81 may be variable, it is appreciated that when coupling the soundbox and the soundboard 76, the surface area of the plates substantially overlap to maximize electromagnetic attraction between the soundbox and soundboard of a stringed instrument. In another embodiment, the pegs may themselves be magnetized (e.g., ferrous metal peg), and placed into a corresponding recessed hollow coupling containing a magnetically charged material. It is further appreciated that the attachment of the soundbox to the soundboard of a stringed instrument can be achieved by placing the pegs on the instrument and recessed hollow couplings on the soundbox, or using various combinations of pegs and holes on one piece with corresponding pegs and holes on the other. The assembled combination of stringed instrument 80 and soundbox 76 is depicted in FIGS. 4A and B. FIG. 4A depicts a smaller portable stringed instrument, such as a folk harp, being used with a smaller soundbox. FIG. 4B depicts a larger stringed instrument, such as a pedal harp, being used with a smaller soundbox. It is appreciated that an instrument user can select combinations of different sized stringed instruments and vary the soundbox size and shape depending on the instrument user's needs.

By providing attachment between the soundbox and soundboard of a stringed instrument, the user can assemble and disassemble the instrument for transport, without sacrificing the acoustic benefits of a larger instrument of fixed height and width. Provided is a method of attaching the stringed instrument to a soundboard assembly, where a user rest the soundboard assembly on a surface and joins the stringed instrument to the soundboard assembly, in a manner that removably attachable/detachable.

Various forms of attachment can be used for joining the soundbox and soundboard of a stringed instrument including male pegs and female hollowed couplings and/or magnetic plates as described. In other embodiments, forms of attachment are combinations of one or more of the following: male pegs and female hollowed couplings, magnetic plates, male screws and female couplings, snap fittings, Velcro, permanent/semi-permanent adhesives including as glues and tapes, nails, nuts and bolts, string/wire, and other elements that will be readily apparent to those of skill in the art.

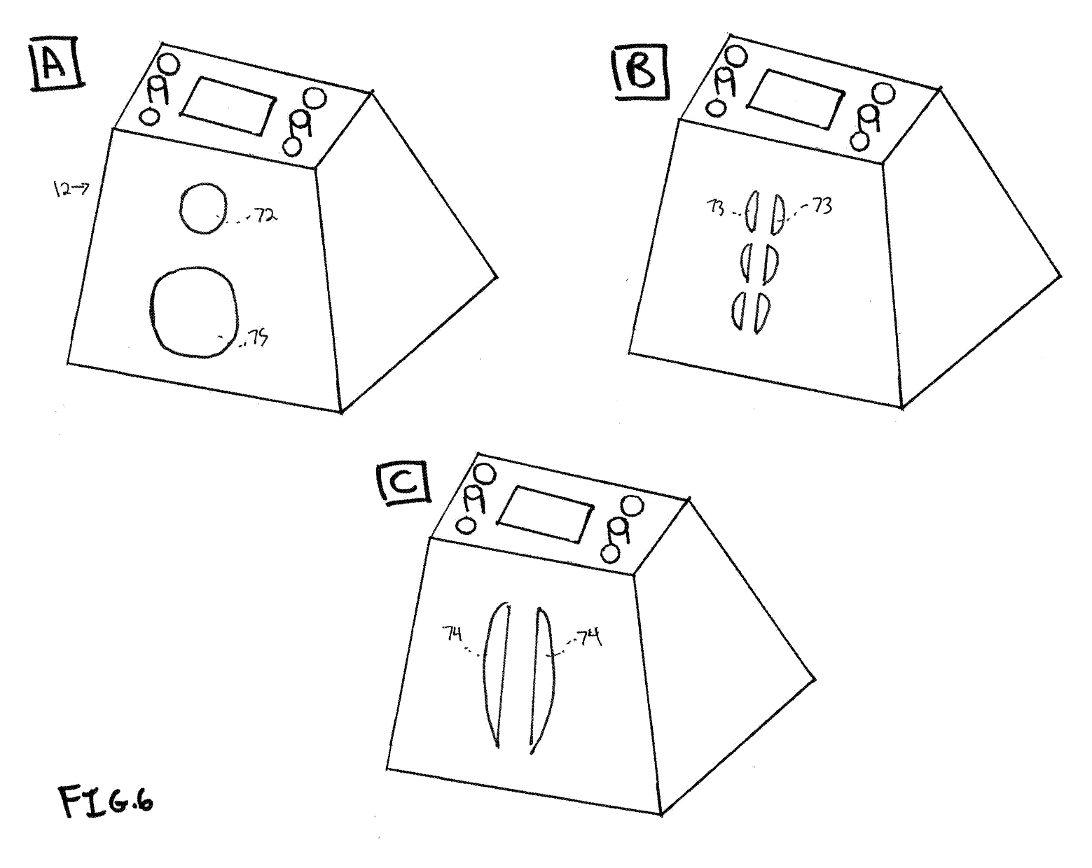

In another embodiment of the subject matter, the soundbox 76 may have alternative configurations or construction with respect to the sound hole as depicted in various embodiments presented in FIG. 6A-C. This includes designs with a single sound hole, or a plurality of sound holes of variable position, shape and size. Positioning of sound hole(s) along the soundboard affects the available surface area of materials for vibration of the sound emanating from the strings, thereby altering the magnitude of sound, and emitted frequencies. Furthermore, the shape and size of the sound hole(s) further affects sounds produced by a stringed instrument. As an example, a smaller hole allows preservation of greater amounts of surface area material, thereby promoting production of lower frequency deep bass tones by sustaining longer sound vibration and reduction in wave cancellation. However, overall volume may be lowered by the reduced size of the hole from which air molecules vibrating within the chamber of the soundbox can escape. The sound hole may constitute a plurality of holes. By utilizing a plurality of holes 72 and 75 preserves surface area, while enabling escape of air molecules, thus representing a means by which both bass tones and volume can be preserved and adjusted to volume and vary the sound characteristics of the instrument. Other examples include altering the shape of the sound hole, including use of circles 72 and 75, semi-circles, oblong variants of circles and semicircles, wedges 73, slices 74, irregular shapes (e.g., kidney bean) and other shapes readily known to one of skill in the art. Position of the sound hole may also be altered to change the sound emitted by the stringed instruments. As an example, sound hole(s) may also be placed at the upper 72 or lower 75 part of a soundbox 76 to vary position in order to vary emission of low and high frequencies.

In another embodiment, the present invention is a soundbox 76, wherein the rear portion 71 is substantially circular (i.e. rounded) as depicted in FIGS. 5E and F. In various embodiments, the rear portion 71 of the soundbox 76 is formed by joining curvilinear edges present on a rear plate 84 and one or more side walls 83 to form a hollow core. A soundbox with rounded edge wall, as depicted in FIG. 5F, can be joined with the bottom of stringed instrument containing a rounded edge wall, as depicted in FIG. 5C. A substantially circular shape for the rear portion 71 provides has several acoustic benefits, including elimination of perpendicular corners from which air molecules reflect off of perpendicular panels, thereby slowing velocity and reducing sound volume produced by the soundboard or trapping air molecules in corners produced by perpendicular panels causing sound distortion. Additionally, the expanded rounded portion 71 provides a means of “opening up” the stringed instrument's unique sound properties, similar to that provided by the “belly” of an instrument, without the potential drawbacks of mechanical failure associated with a “belly” due to deformation. Further, a substantially circular rear portion provides ergonomic benefits by eliminating sharp edges, which improves usage for a stringed instrument user playing the instrument by tipping the instrument along the bottom edge of the instrument and resting the instrument's rear portion against the round space created by the instrument user's legs (e.g., space been the thighs when sitting upright with knees bent on a seat).

In various embodiments, the soundboard assembly, including the soundboard and soundbox, may be constructed of wood, metals, polymers, or other synthetic and non-synthetic materials. Examples include walnut, maple, cherry, ash, mahogany, purple heart, bubinga, birch, cedar, red wood, sitka spruce, veneer stock, and/or plywood. In one embodiment, the soundboard assembly thin materials, such as several thicknesses of veneer stock glued and cross-laminated to give it strength in two dimensions.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the presence or absence of structural elements comprising the apparatus, compatible alterations in the shape, size, position and orientation of various structural elements in a manner consistent with the teachings of the invention, suitable materials and methods for construction or modification, and the particular use of the products created through the teachings of the invention. Various embodiments of the invention can specifically include or exclude any of these variations or elements.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. An assembly for a stringed instrument, comprising:
a front plate, a rear plate, two side walls, and a top plate, the two side walls each attached on one end to the front plate, each attached at another end to the rear plate, and the top plate attached to the front plate, rear plate and two side walls thereby forming a hollow core;
means for removable attachment configured on the top plate; and
at least one sound hole in the front plate.

2. The assembly of claim 1, wherein the means for removable attachment is selected from the group consisting of pegs, dowels, screws, hollowed couplings, magnetic plates, snap fittings, nuts, bolts and combinations thereof.

3. The assembly of claim 1, wherein the at least one sound hole is independently selected from the group consisting of circles, semi-circles, oblong variants of circles and semicircles, wedges, slices, irregular shapes and combinations thereof.

4. The assembly of claim 1, wherein the rear plate further comprises at least one sound hole.

5. The assembly of claim 1, further comprising at least one additional side wall.

6. The assembly of claim 1, further comprising a bottom plate attached to the front plate, rear plate and two side walls.

7. The assembly of claim 1, wherein the rear plate and two side walls comprise curvilinear edges so as to form a substantially rounded shape.

8. In combination, the assembly of claim 1 and a stringed instrument comprising a soundboard, wherein the stringed instrument comprises means for instrument removable attachment on the soundboard, adapted to removably interact with the means for removable attachment configured on the top plate.

9. The combination of claim 8, wherein the means for instrument removable attachment is selected from the group consisting of pegs, dowels, screws, hollowed couplings, magnetic plates, snap fittings, nuts, bolts and combinations thereof.

10. The combination of claim 8, wherein the stringed instrument further comprises:
a neck connected to the soundboard;
a column mounted on the soundboard; and
a plurality of strings connected between the soundboard and the neck.

11. The combination of claim 10, wherein the stringed instrument further comprises a plurality of pins mounted on the neck, wherein the plurality of strings are attached to the pins.

12. The combination of claim 10, wherein the soundboard comprises at least two notches for attachment of a plurality of strings.

13. The combination of claim 10, further comprising a strip fixed on the soundboard for attaching a plurality of strings.
